(19) United States
(12) Patent Application Publication
(10) Pub. No.: US 2011/0079363 A1
(43) Pub. Date: Apr. 7, 2011

(54) Scented window screens

(76) Inventor: Loreal Kelly Jefferson, Philadelphia, PA (US)

(21) Appl. No.: 12/587,379

(22) Filed: Oct. 7, 2009

(51) Int. Cl. E06B 9/24

(52) U.S. Cl. 160/127

(57) ABSTRACT

A window screen which has a perfumed picture made from fragrant gels that are infused within the window screen. The Scented Window Screen provides an entirely new way for one to freshen one's home and also provide a decorative accent to a room. The window screen is adjustable to fit most standard size windows. As air from outside passes through the Scented Window Screen said air will carry with it into the home the fragrance from the Scented Window Screen and freshen the home.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable.

### BACKGROUND OF THE INVENTION

(1) Field of the Invention

Scented Window Screens would pertain to the field of home fragrance. Scented Window Screens are designed to provide a fresh scent and offer pleasant scenery in a home.

(2) Description of the Related Art Including Information Disclosured Under 37 CFR 1.97 and 37 CFR 1.98

Scented Window Screens will combine the functionality of everyday simple adjustable window screens with home fragrance to make one product that is functional and decorative.

### BRIEF SUMMARY OF THE INVENTION

The invention that I, Loreal Kelly Jefferson, sole inventor would like to have patented is named Scented Window Screens. Scented Window Screens are made from your everyday ordinary window screens and the same type of household gelled fragranced air fresheners that are in common use today. Scented Window Screens will emit a fragrance that the picture depicts. For example, a Scented Window Screen with a picture of a colorful flower field will have an aromatic flowery scent. Scented Window Screens would offer a fresh scent and nice picture for everyone who uses them. Scented Window Screens would be especially perfect for city living. City living offers little relief in the way of fresh air and a scenic view. People who live in the city are greeted with smog, stale air and a concrete jungle when opening a window for a chance at fresh air and nice view. Scented Window Screens would break city livers out of that rut and offer a wonderful fragrance and gorgeous view.

### BRIEF DESCRIPTION OF THE SEVERAL VIEWS OF THE DRAWINGS

The enclosed illustrations of the Scented Window Screens shows first in

FIG. 1a simple window screen with accordion style sides. This window screen is much like all window screens that are currently used in homes today. The screen would be adjustable to fit most standard size windows.

FIG. 2 illustrates the depiction of perfumed gels that have been arranged to take on the look of a serene beach front.

FIG. 3 is the transparent perforated plastic that will go on top of the fragrant gels. This plastic will allow scent to flow through the holes, but also help maintain the integrity of the fragrant gels.

FIG. 4 illustrates the combination of the window screen with the scented gels and the sheet of transparent perforated plastic that now form Scented Window Screens.

FIG. 5 is an example of an ordinary kitchen window without a view.

FIG. 6a shows one Scented Window Screen in place. And finally, FIG. 6b depicts both Scented Window Screens in place. FIGS. 7 through 11 illustrates other fragrances of Scented Window Screens such as Country Flowers as shown in FIG. 7, Ocean Breeze as shown in FIG. 8, Mountain Spring as shown in FIG. 9, Autumn Spice as shown in FIG. 10 and Sweet Dreams as shown in FIG. 11.

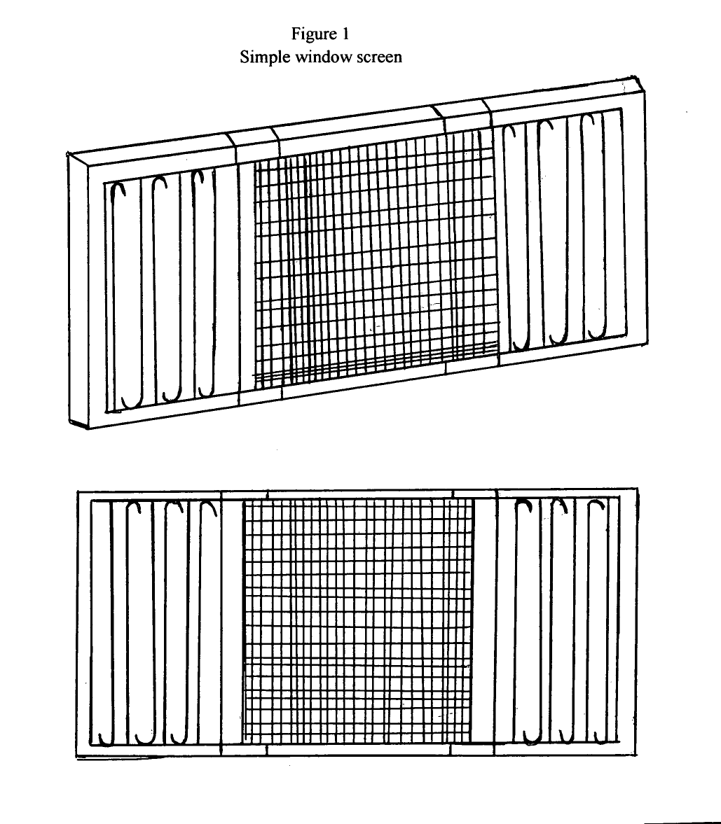

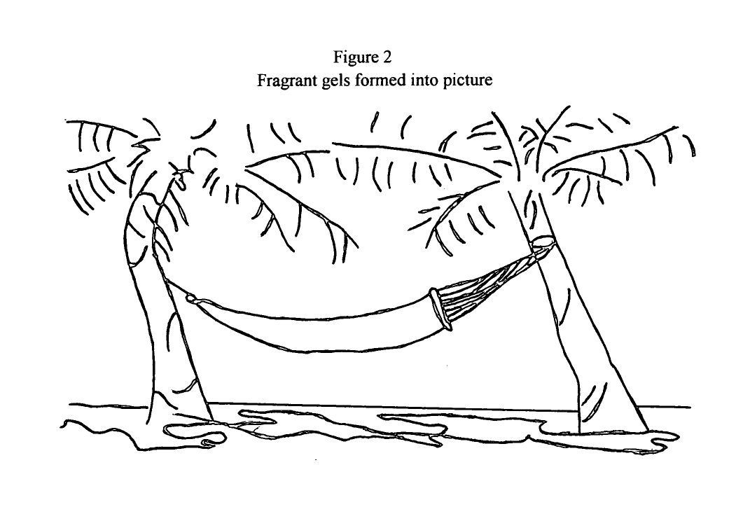

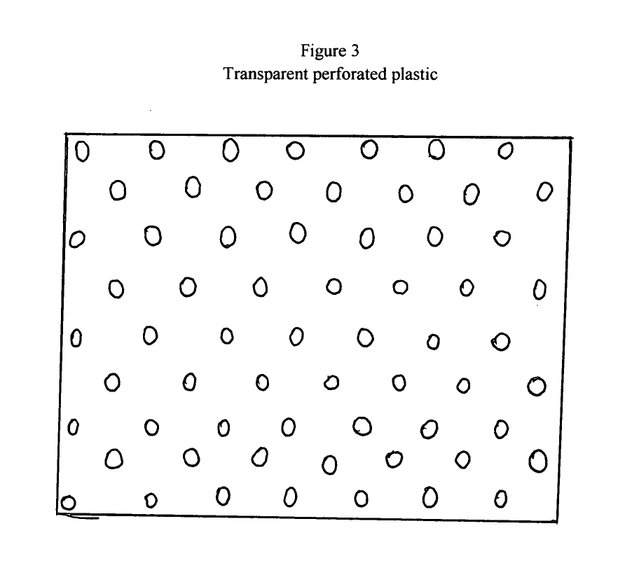

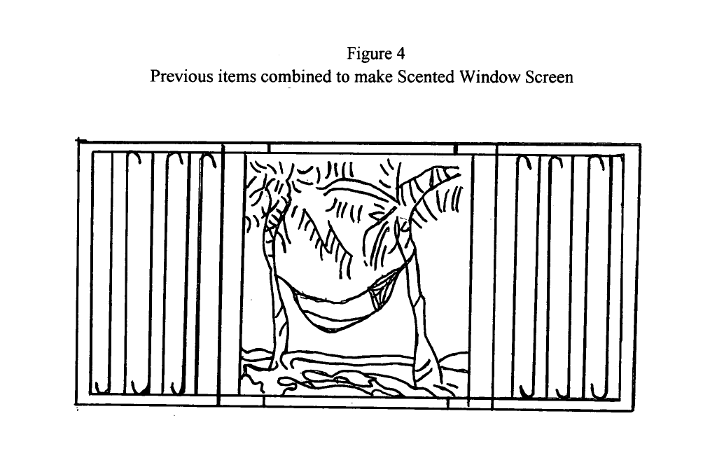

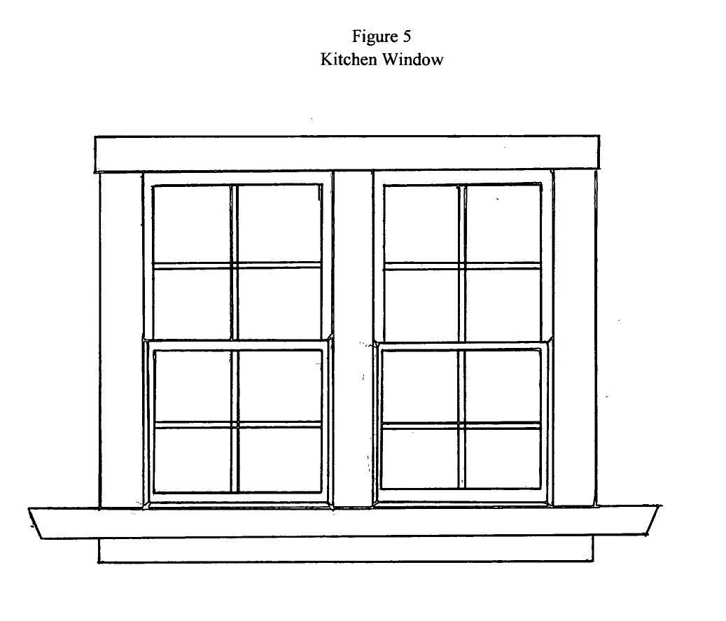

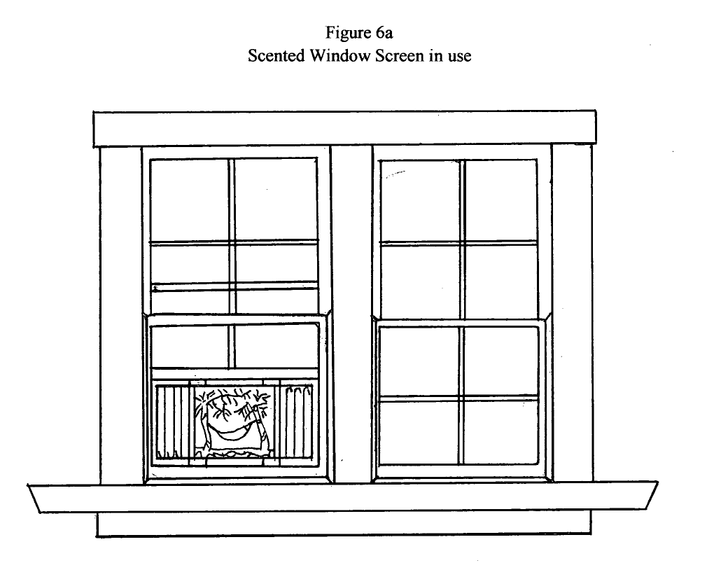

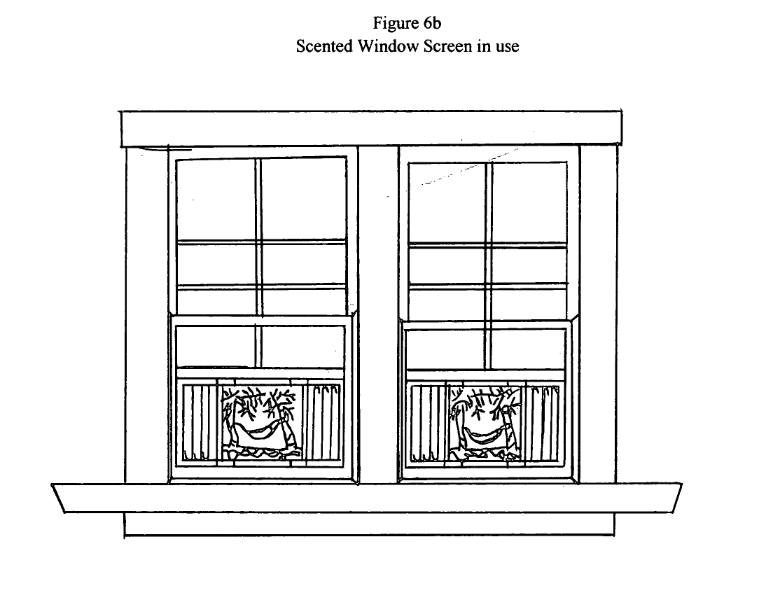

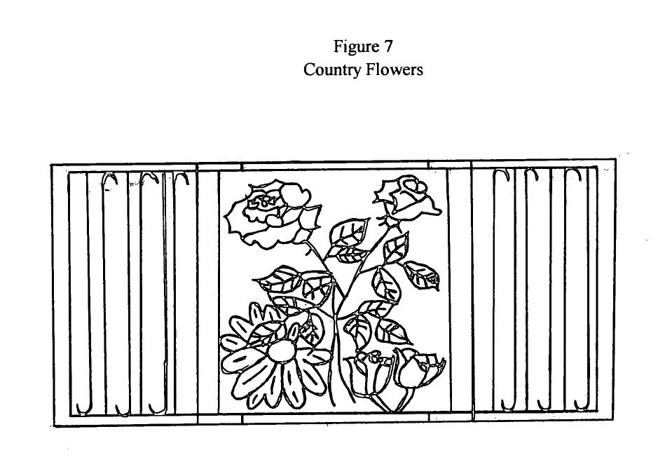

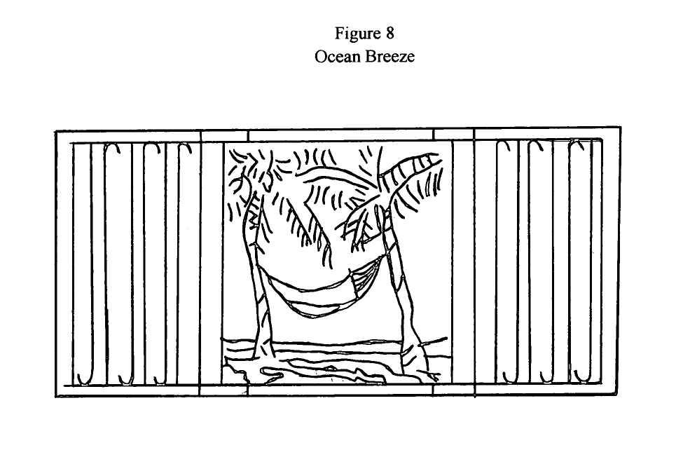

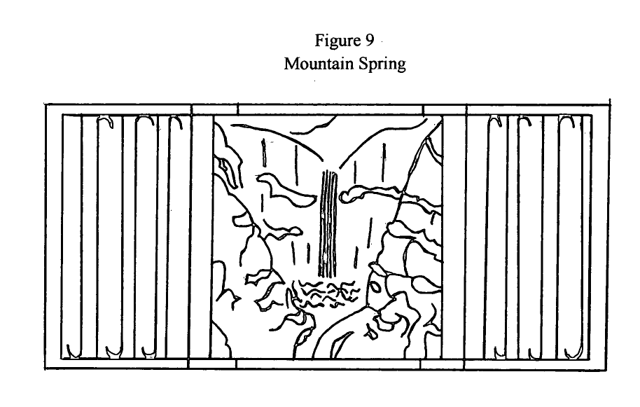

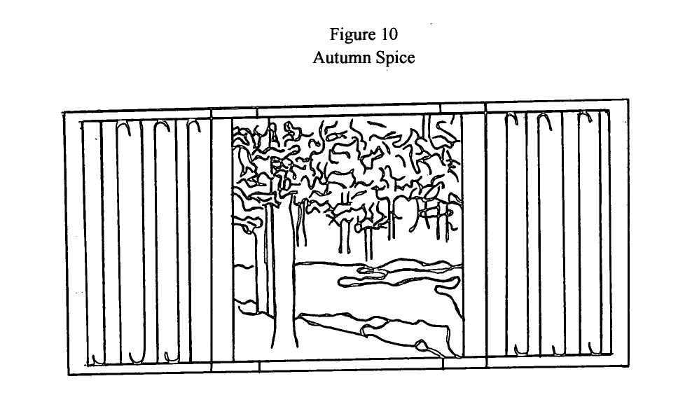

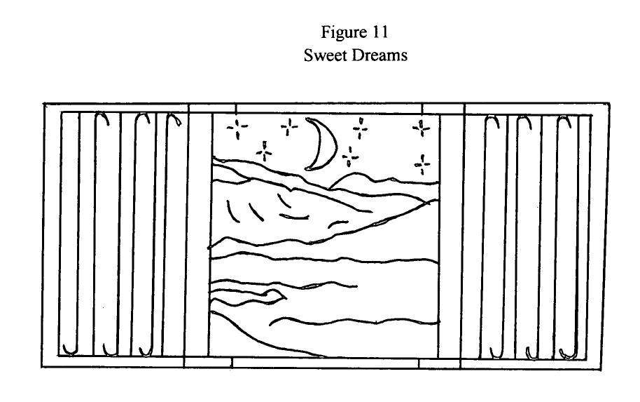

### DETAILED DESCRIPTION OF THE INVENTION

Scented Window Screens are comprised of adjustable window screens, fragrant gels and transparent perforated plastic. The adjustable window screen is your average everyday window screen that is typically made of aluminum, plastic, and/or fiberglass screen wire. The adjustable window screens will have accordion style adjustable sides. The window screens are easy to install and do not require any tools or fasteners. Simply put the screen in the window, stretch to desired width and pull the window down on top of the window screen to hold in place. The fragrant gels that will be used to make Scented Window Screens will be of a jellied-like consistency much like that of existing home fragrance products. The gels that will be used in the production of Scented Window Screens will come in a variety of colors and fragrances to achieve the desired illustrative and aromatic outcome. The Scented Window Screens will be available in such fragrances as Country Flowers, Ocean Breeze, Mountain Spring, Autumn Spice, and Sweet Dreams. The Scented Window Screen in the country flowers scent will embody such floral fragrances as peonies, violets, orchids, roses and vanilla. The ocean breeze Scented Window Screen will have such scents as jasmine, rose, geranium, coconut, grapefruit and driftwood. The Scented Window Screen in the Mountain Spring fragrance will contain such scents as water lilies, baby powder, grass and pine. The autumn spice Scented Window Screen will include such fragrances as pumpkin, clove, cinnamon, nutmeg and vanilla. The Scented Window Screen in the sweet dreams scent will have such fragrances as lavender, chamomile, vanilla and sandalwood. Scented Window Screens are functional and decorative. Scented Window Screens when secured in a window opening will keep out bugs, dirt and pollen while allowing fresh air inside the home. The fragrant gels that are purposely arranged in to scenic views will provide a beautiful image and appealing aroma.

1. A window screen with according style sides comprising a fragrance and picture made from fragrant gels wherein said window screen will have said fragrance and said picture infused within the screen while said picture would represent the said fragrance; i.e. (country flower fragrance would have a picture of country flowers), said scented window screen will have a fragrance and picture that would evaporate with use; once fragrance has evaporated said scented window screen can function as a simple window screen and therefore said window screen will be made to fit most standard size windows.

2. Scented Window Screens will combine the functionality of everyday simple adjustable window screens with home fragrance to make one product that is functional and decorative.

3. Any window screen with fragrance infused within said window screen.
